(19) United States
(12) Patent Application Publication
(10) Pub. No.: US 2004/0034738 A1
(43) Pub. Date: Feb. 19, 2004

(54) Structure of an extendable and detachable USB memory

(76) Inventor: Ke-Pu Huang, Taipei (TW)

Correspondence Address: Ke-Pu Huang, PO Box 82-144, TAIPEI, TW

(21) Appl. No.: 10/216,734

(22) Filed: Aug. 13, 2002

(51) Int. Cl. G06F 12/00

(52) U.S. Cl. 711/115

(57) ABSTRACT

An improved structure of an extendable and detachable USB memory is disclosed and the USB memory is either an externally connected variable capacity memory or a built-in variable capacity memory. The externally connected variable capacity memory includes a controller and flash memory section of various types of memory capacity connected in series, wherein the controller comprises a USB connector or socket for connection with computer USB interface and a connector for the insertion of the flash memory; and the flash memory section does not have fixed capacity but has an thermal insertion and detaching and write-in proof design, and is provided at one end a connector for the insertion of the controller and the other end is the required connector for the subsequent extension of flash memory; and the built-in variable memory having the controller section being built in the computer or a digital product such that the controller section is connected to the USB interface of the computer of the digital product by means of USB connector or socket such that the surface of the computer or the digital product exposes at least one group of connector needed for the plugging of the flash memory.

### BACKGROUND OF THE INVENTION

(a) Technical Field of the Invention

The present invention relates to extendable and detachable USB memory, and in particular, to structure of USB memories which can be either externally connected in series or built-in USB memory.

(b) Description of the Prior Art

Referring to FIG. 1, computer or a digital product is normally provided with a USB interface connector for externally connection of memory, and the USB interface is effectively used to control the externally connected memory so as to implement data storage or the read/write the data within the memory so that the computer or the digital product is provided with a simple externally connection function. However, due to the various specifications of memories, correct types of memories have to be purchased or selected for expansion of memory capacity. As shown in FIG. 1, the structure of the memory is provided with at least a USB interface connector A1 for the connection with the exposed USB connector A21 of the computer or the digital product A2, and by means of at least a controller A3, the operation A4 of the flash memory is controlled.

The USB interface connector A1 and the connector A21 are standard interface specification and the main mechanism of the controller depends on the number of the flash memory. Therefore, on the circuit board having a fixed space, the memory of the flash memory A4 is fixed and cannot be varied and cannot be used in other types of digital products. In view of the above, a specific memory can only be used in a specific product.

In view of the above, it is an object of the present invention to provide an improved structure of an extendable and detachable USB memory which can solve the above-mentioned drawbacks.

### SUMMARY OF THE INVENTION

Accordingly, it is an object of the present invention to provide an improved structure of an extendable and detachable USB memory having either an externally connected variable capacity memory or a built-in variable capacity memory, characterized in that the externally connected variable capacity memory includes a controller and flash memory section of various types of memory capacity connected in series, wherein the controller comprises a USB connector or socket for connection with computer USB interface and a connector for the insertion of the flash memory; and the flash memory section does not have fixed capacity but has an thermal insertion and detaching and write-in proof design, and is provided at one end a connector for the insertion of the controller and the other end is the required connector for the subsequent extension of flash memory; and the built-in variable memory having the controller section being built in the computer or a digital product such that the controller section is connected to the USB interface of the computer of the digital product by means of USB connector or socket such that the surface of the computer or the digital product exposes at least one group of connector needed for the plugging of the flash memory.

An aspect of the present invention is to provide an improved structure of an extendable and detachable USB memory, wherein the controller section includes a read/write indicator.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of the basic structure of a conventional externally-connected memory.

FIG. 2 is a perspective view showing the application of the structure of a preferred embodiment in accordance with the present invention.

FIG. 3 is a schematic view showing the structure I of the preferred embodiment in accordance with the present invention.

FIG. 4 is a schematic view showing the structure II of the preferred embodiment in accordance with the present invention.

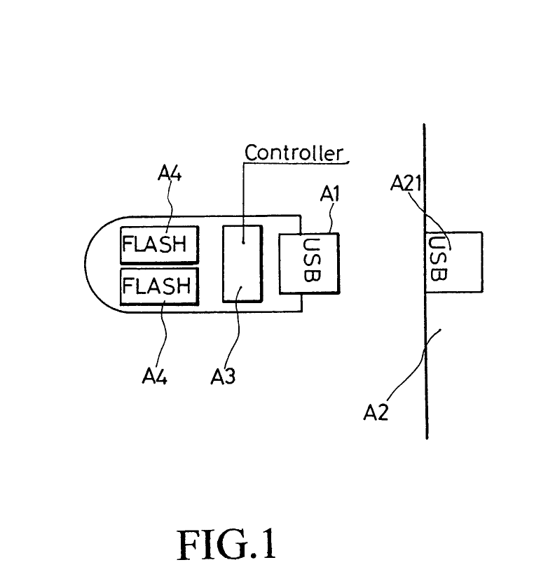

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

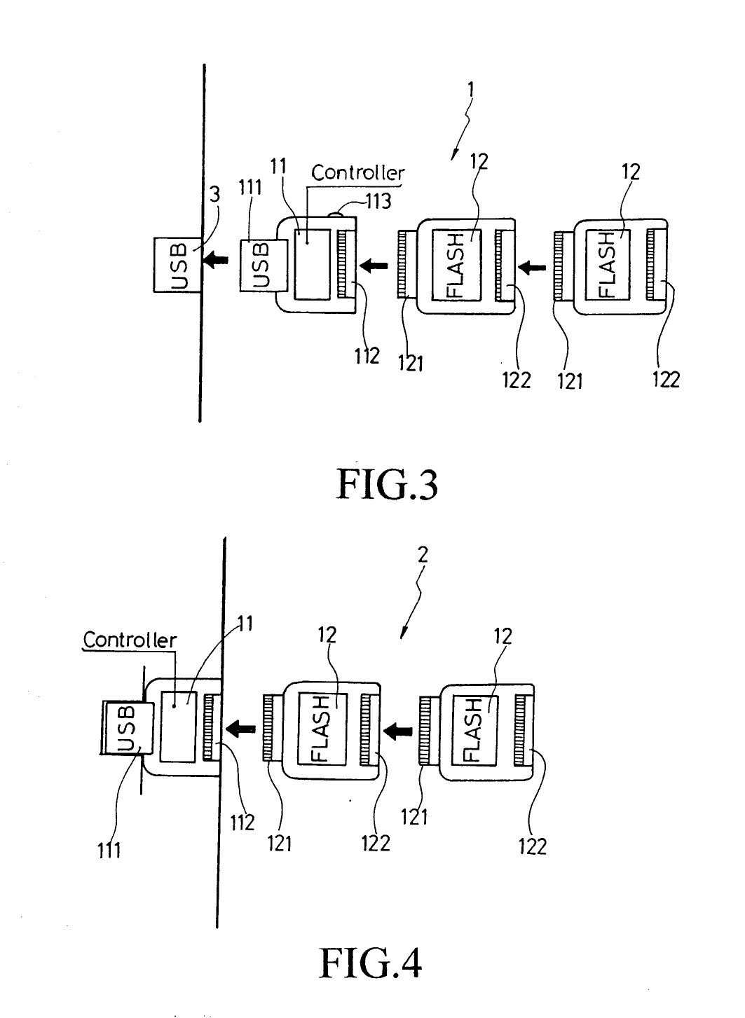

Referring to FIGS. 3 and 4, there is shown an improved structure of an extendable and detachable USB memory having either an externally connected variable capacity memory 1 or a built-in variable capacity memory 2. In accordance with the present preferred embodiment, the externally connected variable capacity memory 1 (as shown in FIG. 3) includes a controller 11 and flash memory section 12 of various types of memory capacity connected in series, wherein the controller 11 comprises a USB connector or socket 111 for interface-connection with computer USB 3 and a connector 112 for the insertion of the flash memory 12 and a read/write indicator 113; and the flash memory 12 section does not have fixed capacity but has an thermal insertion and detaching and write-in proof design. The capacities can be 16 MB, 32 MB, 64 MB, etc., and is provided at one end a connector 121 for the insertion of the controller 11 and the other end is the required connector 12s for the subsequent extension of flash memory 12 in series.

As shown in FIG. 4, the built-in variable memory 2 is provided with the controller section 11 being built in the computer or a digital product such that the controller section 11 is connected to the USB interface of the computer of the digital product by means of USB connector or socket such that the surface of the computer or the digital product exposes at least one group of connector 112 needed for the plugging of the flash memory 12.

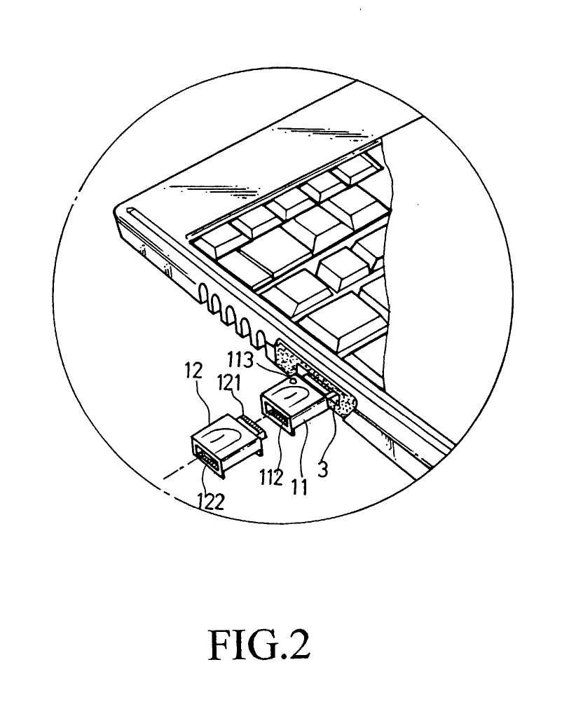

FIG. 2 shows the method of implementing the present invention. The expansion of the memory is attained by connection in series and therefore consumers can expand the memory by connection of the memory to comply with one's requirement.

The present inspection device has the following advantages:

(1) The capacity of the memory is expanded by connection in series and therefore it is adapted for various kinds of digital products.

(2) The present invention is provided with the mechanism of controlled thermal insertion/unplug function and write-in proof function.

(3) Cost of application is lowered as expensive memory such as 64 MB can be avoided as the 64 MB can be formed by connecting memories consisting of 32 MB, 16 Mb, and 16 MB.

(4) The cost of memory devices is kept constant.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of an extendable and detachable USB memory having either an externally connected variable capacity memory or a built-in variable capacity memory, characterized in that the externally connected variable capacity memory includes a controller and flash memory section of various types of memory capacity connected in series, wherein the controller comprises a USB connector or socket for connection with computer USB interface and a connector for the insertion of the flash memory; and the flash memory section does not have fixed capacity but has an thermal insertion and detaching and write-in proof design, and is provided at one end a connector for the insertion of the controller and the other end is the required connector for the subsequent extension of flash memory; and the built-in variable memory having the controller section being built in the computer or a digital product such that the controller section is connected to the USB interface of the computer of the digital product by means of USB connector or socket such that the surface of the computer or the digital product exposes at least one group of connector needed for the plugging of the flash memory.

2. The structure of claim 1, wherein the controller section includes a read/write indicator.
